(19) United States
(12) Patent Application Publication
(10) Pub. No.: US 2019/0378063 A1
(43) Pub. Date: Dec. 12, 2019

(54) SIMULATION OF INFORMATION SEARCHING ACTION IN ACCORDANCE WITH USE EXPERIENCE OF A USER

(71) Applicant: FUJITSU LIMITED, Kawasaki-shi (JP)

(72) Inventors: Hiroaki Yamada, Kawasaki (JP); Kotaro Ohori, Sumida (JP); Shohei Yamane, Kawasaki (JP)

(73) Assignee: FUJITSU LIMITED, Kawasaki-shi (JP)

(21) Appl. No.: 16/434,278

(22) Filed: Jun. 7, 2019

(30) Foreign Application Priority Data
Jun. 8, 2018 (JP) 2018-110652

(51) Int. Cl. G06Q 10/06

(52) U.S. Cl. CPC G06Q 10/067

(57) ABSTRACT

An apparatus simulates an agent performing a checking action that sequentially checks a plurality of selection candidates for each of which an expected value is set. The apparatus calculates, for the agent, a biased expected value of each of the plurality of selection candidates, based on an experience score set for the agent and the expected value of each of the plurality of selection candidates. The apparatus simulates the check action of sequentially checking each of the plurality of selection candidates of the agent, by performing a continuation judgment of determining whether the checking action is to be performed for a next one of the plurality of selection candidates, based on an evaluated value set to a selection candidate that has been already checked and a biased expected value set to a selection candidate that is not checked yet.

### CROSS-REFERENCE TO RELATED APPLICATION

This application is based upon and claims the benefit of priority of the prior Japanese Patent Application No. 2018-110652, filed on Jun. 8, 2018, the entire contents of which are incorporated herein by reference.

### FIELD

The embodiments discussed herein are related to simulation of information searching action in accordance with use experience of a user.

### BACKGROUND

In a case of designing a layout of tenants (hereinafter, also referred to as small facilities) in a facility such as a department store, a shopping mall, or the like, a simulation of an information searching action of a human (hereinafter, also referred to as a searching action) is utilized. In this simulation, in a virtual space corresponding to the facility such as the department store, the shopping mall, or the like, each tenant and a user agent imitating a user (hereinafter, also referred to as an agent) are arranged. By simulating in which order the agent visits the respective tenants, a flow of the user in the department store or the shopping mall is imitated.

On the other hand, in the real world, it is known that in a case where a plurality of tenants is resident in a certain facility, a person who visits the facility for the first time makes a purchase judgment at several shops attracting the attention thereof, and a repeater makes a purchase judgment after a sufficient search of the facility. That is, for example, it is known that depending on an amount of knowledge (experience value) for use of the facility, an information searching action before the purchase changes.

Japanese National Publication of International Patent Application No. 2017-502401, Japanese Laid-open Patent Publication Nos. 2016-004353, 2006-221329, 2016-164750, 2004-258762, and 2008-123487 are examples of related art.

Bettman, J. R., & Park, C. W., “Effects of Prior Knowledge and Experience and Phase of the Choice Process on Consumer Decision Processes: A Protocol Analysis.”, Journal of Consumer Research, (1980), 7-234-248 and Johnson, E. J., & Russo, J. E., “Product Familiarity and Learning New Information.”, Journal of Consumer Research, (1984), 11-542-550 are examples of related art.

### SUMMARY

According to an aspect of the embodiments, an apparatus simulates an agent performing a checking action that sequentially checks a plurality of selection candidates for each of which an expected value is set. The apparatus calculates, for the agent, a biased expected value of each of the plurality of selection candidates, based on an experience score set for the agent and the expected value of each of the plurality of selection candidates. The apparatus simulates the check action of sequentially checking each of the plurality of selection candidates of the agent, by performing a continuation judgment of determining whether the checking action is to be performed for a next one of the plurality of selection candidates, based on an evaluated value set to a selection candidate that has been already checked and a biased expected value set to a selection candidate that is not checked yet.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a functional configuration of a simulation apparatus according to a first embodiment;

FIG. 2 is a diagram illustrating an example of a simulation of a searching action using an expected value and an actual evaluated value;

FIG. 3 is a diagram illustrating an example of a classification of the searching action in the simulation;

FIG. 4 is a diagram illustrating an example in a case where the searching action is expressed by manipulating dispersion of the expected value;

FIG. 5 is a diagram illustrating an example of a difference in the searching action by a difference in evaluation of an unsearched facility;

FIG. 6 is a diagram illustrating an example of an expected value average and a biased expected value;

FIG. 7 is a diagram illustrating an example of selection candidate information;

FIG. 8 is a diagram illustrating an example of experience information;

FIG. 9 is a diagram illustrating an example of layout information;

FIG. 10 is a diagram illustrating an example of the searching action using the biased expected value and the actual evaluated value;

FIG. 11 is a diagram illustrating an example of the searching action in a case where the biased expected value is set for an expert;

FIG. 12 is a diagram illustrating an example of the searching action in a case where the biased expected value is set for a novice;

FIG. 13 is a diagram illustrating an example of the searching action in a case where the biased expected value is set for a middle;

FIG. 14 is a flowchart illustrating an example of determination processing of the first embodiment;

FIG. 15 is a block diagram illustrating an example of a functional configuration of a simulation apparatus according to a second embodiment;

FIG. 16 is a diagram illustrating an example in a case where the biased expected value is changed by repeated use;

FIG. 17 is a diagram illustrating another example in the case where the biased expected value is changed by the repeated use;

FIG. 18 is a flowchart illustrating an example of determination processing of the second embodiment;

FIG. 19 is a block diagram illustrating an example of a functional configuration of a simulation apparatus according to a third embodiment;

FIG. 20 is a flowchart illustrating an example of determination processing of the third embodiment;

FIG. 21 is a block diagram illustrating an example of a functional configuration of a simulation apparatus according to a fourth embodiment;

FIG. 22 is a diagram illustrating an example of calculation of a satisfaction level and a satisfaction level gap;

FIGS. 23A to 23D are diagrams each illustrating an example of evaluation of a layout design;

FIG. 24 is a diagram illustrating an example of comparison of a user scenario; and

FIG. 25 is a block diagram illustrating an example of a hardware configuration of the simulation apparatus according to each of the embodiments.

### DESCRIPTION OF EMBODIMENTS

In the imitating the flow of the user in the above-described simulation, it is not considered whether the user visits the facility for the first time or is the repeater. Accordingly, it is difficult to reproduce the searching action in accordance with use experience of the user of the facility.

Embodiments of a recording medium, a simulation method, and a simulation apparatus disclosed in the present application will be described in detail below with reference to the drawings. Note that disclosed techniques are not intended to be limited to the embodiments. The following embodiments may be appropriately combined in a range without inconsistency.

### First Embodiment

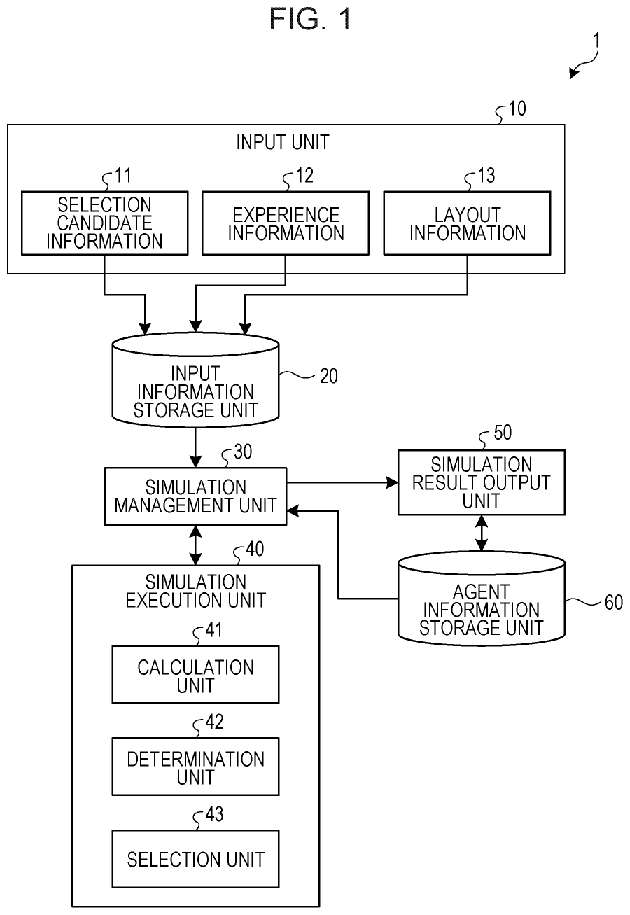

FIG. 1 is a block diagram illustrating an example of a functional configuration of a simulation apparatus according to a first embodiment. A simulation apparatus 1 illustrated in FIG. 1 is an information processing apparatus such as a personal computer (PC), or the like, for example. In the simulation apparatus 1, an agent performs a checking action for checking a plurality of selection candidates, for each of which an expected value is set, in order. Based on an experience score set for the agent and the expected value of each of the plurality of selection candidates, the simulation apparatus 1 calculates a biased expected value of each of the plurality of selection candidates for the agent. The simulation apparatus 1 performs a continuation judgment of the checking action for each check of the selection candidate by the agent, based on the biased expected value of an unchecked selection candidate and an evaluated value of a checked selection candidate. With this, the simulation apparatus 1 may reproduce a searching action in accordance with user experience.

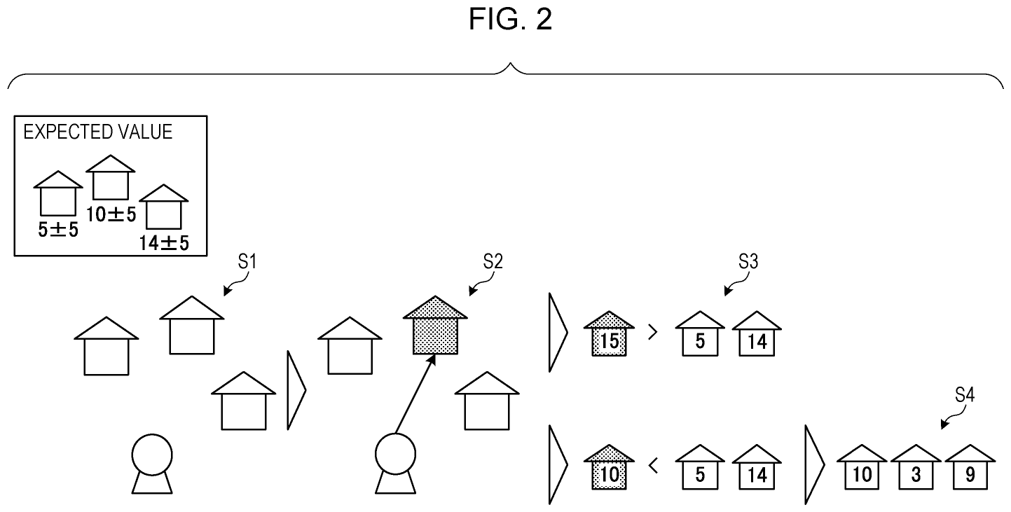

First, with reference to FIG. 2 to FIG. 6, the searching action using the expected value and an actual evaluated value, and the biased expected value will be described. FIG. 2 is a diagram illustrating an example of a simulation of the searching action using the expected value and the actual evaluated value. As illustrated in FIG. 2, in the simulation of the searching action, the expected value of each small facility in a certain facility is input (step S1). The expected value is a predicted satisfaction level to articles in the small facility, and is a value having an average and dispersion. Next, in the simulation, a visit destination is decided from a preference for each small facility and time restriction. The decided visit destination is visited and the actual evaluated value is calculated (step S2). Next, in the simulation, when the calculated actual evaluated value is higher than the expected values of all the unsearched small facilities and other actual evaluated values (upper portion in step S3), the search is ended, and the article is purchased in the small facility (step S4). When the calculated actual evaluated value is not higher than the expected values of all the unsearched small facilities and other actual evaluated values (lower portion in step S3), the processing returns to step S2, and a next visit destination is decided. Note that in step S3, in a case where the search of all candidate small facilities is performed, all the actual evaluated values are compared, and the article may be purchased after returning to a small facility with the highest value among all the actual evaluated values (step S4).

In the simulation of the searching action in FIG. 2, an expert who has much use experience of the facility and makes a purchase judgment by efficiently searching may be expressed. However, in the example in FIG. 2, a novice and a middle, which will be described later, may not be expressed, and it is difficult to reproduce the searching action in accordance with the use experience of the user for the facility.

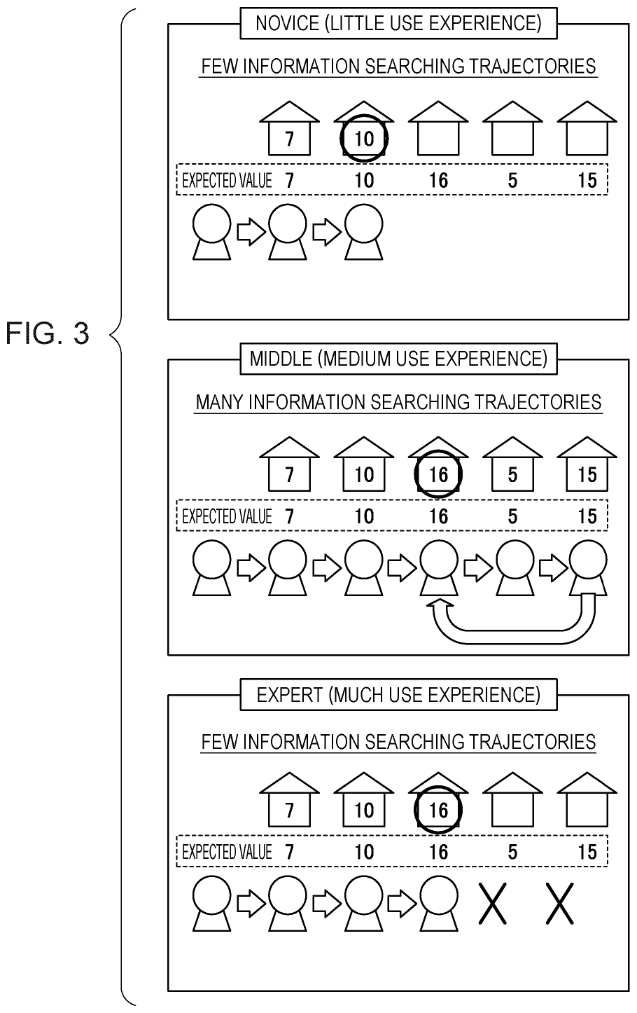

FIG. 3 is a diagram illustrating an example of a classification of the searching action in the simulation. This classification is obtained by classifying the agents in a virtual space while being associated with a classification of humans in the real world. As illustrated in FIG. 3, in the searching action according to the use experience of the user for the facility, classification into three kinds of the novice, the middle, and the expert may be obtained. In FIG. 3, for the sake of simplicity, the expected value and the actual evaluated value have the same value, and descriptions will be given using the expected value.

The novice has little use experience of the facility, and makes the purchase judgment by searching of several near facilities. In other words, for example, the novice is an agent corresponding to a human having a small experience value for the use of the facility. In the example in FIG. 3, if the small facilities with the expected values of “7” and “10” continue in a visiting order, the purchase is judged at the facility with the expected value “10”, and succeeding small facilities thereto are not visited. In other words, for example, the novice may be said to have few information search trajectories.

The middle has medium use experience for the facility, and makes the purchase judgment by widely searching. In other words, for example, the middle is an agent corresponding to a human having a medium experience value for the use of the facility. In the example in FIG. 3, a wide search of the small facilities with the expected values of “7”, “10”, “16”, “5”, and “15” is performed in the visiting order, and the purchase is judged after returning to the facility with the expected value “16”. In other words, for example, the middle may be said to have many information search trajectories.

The expert has much use experience for the facility, and makes the purchase judgment by efficiently searching. In other words, for example, the expert is an agent corresponding to a human having a large experience value for the use of the facility. In the example in FIG. 3, if the small facilities with the expected values of “7”, “10”, and “16” continue in the visiting order, the purchase is judged at the facility with the expected value “16”, and succeeding small facilities thereto are not visited. In other words, for example, the expert may be said to have few information search trajectories.

In the simulation of the searching action in FIG. 2, in a case where the agents expressing the users of the novice, the middle, and the expert are tried to be separately made, for example, manipulating the dispersion of the expected value and processing in accordance with the agent type are considered. Note that the processing in accordance with the agent type is to perform individually modeling for the novice, the middle, and the expert.

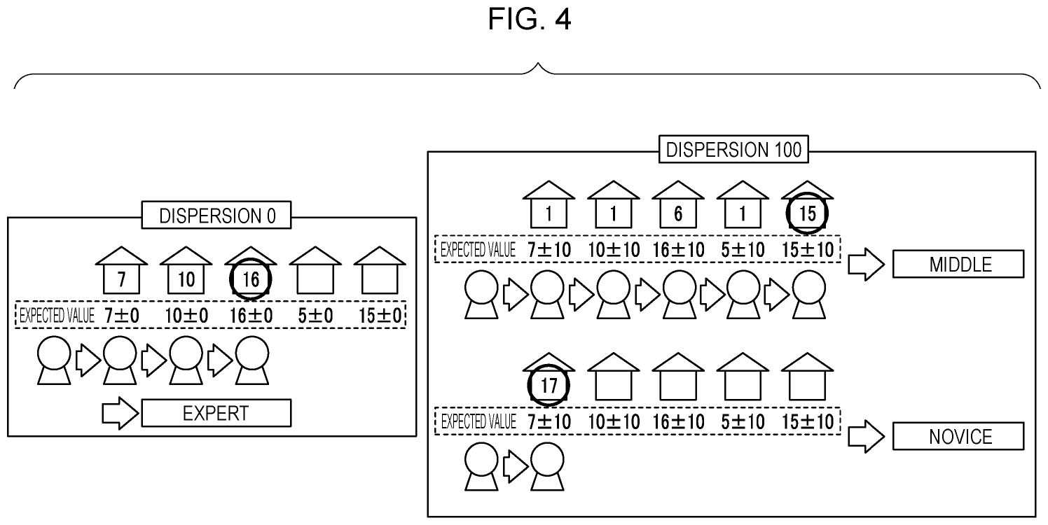

FIG. 4 is a diagram illustrating an example in a case where the searching action is expressed by manipulating the dispersion of the expected value. FIG. 4 illustrates a case where an inaccurate purchase judgment of the novice or the middle is tried to be expressed by manipulating the dispersion of the expected value. In this case, it is possible to express the expert by the dispersion “0”, and it is possible to express both the novice and middle by the dispersion “100”. In other words, for example, in the example in FIG. 4, it is possible to generate users having the different number of information search trajectories. However, since the novice and the middle both have the dispersion “100”, it is not possible to separately make them.

On the other hand, in a case of the processing in accordance with the agent type, the number of portions in which the agent type is determined during the simulation increases. Accordingly, in a case where the number of agents, a simulation space, and time are increased, desired calculation resources rapidly increase.

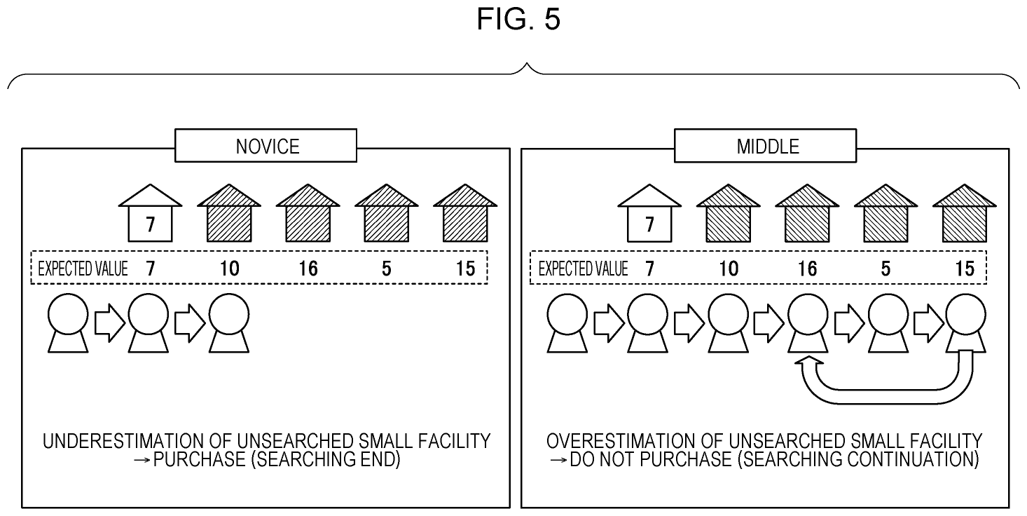

Accordingly, within a framework of determination with the searching action based on comparison of the expected value and the actual evaluated value, changing the searching action is considered. FIG. 5 is a diagram illustrating an example of a difference in the searching action caused by a difference in evaluation of the unsearched facility. As illustrated in FIG. 5, it may be understood that the novice underestimates the unsearched small facilities, judges the purchase at the small facility on a head side in the visiting order, and ends the search. It may be understood that the middle overestimates the unsearched small facilities, continues the search without purchasing at the small facilities on the way, visits all the small facilities, and then returns to the small facility having the highest actual evaluated value. That is, for example, it may be said that the novice and the middle assume different evaluated values for the unsearched facilities.

Accordingly, a point that the novice and the middle assume different evaluated values may be reflected on the expected value. In other words, for example, the difference in the purchase judgment among the novice, the middle, and the expert may be expressed by introducing a biased expected value calculated based on the expected value and the user experience.

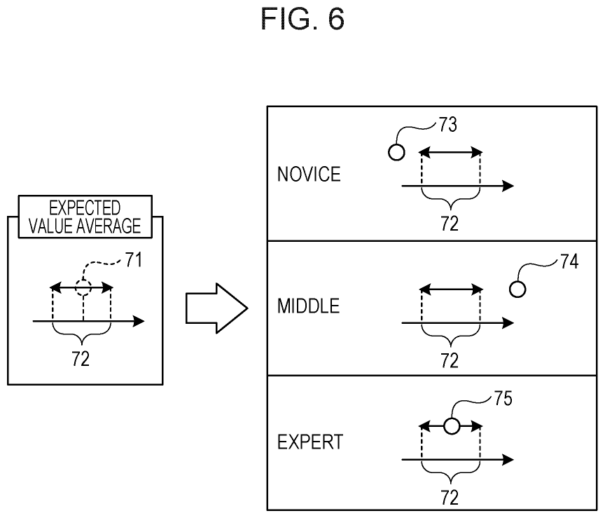

FIG. 6 is a diagram illustrating an example of an expected value average and a biased expected value. As illustrated in FIG. 6, in the simulation of the searching action in FIG. 2, an expected value 71 of the unsearched facility is implicitly assumed to be the expected value of a range 72. By contrast, in a case of the novice, the expected value of the unsearched facility is considered as an expected value biased by the use experience in the past, and a value lower than the expected value of the range 72 is assumed to be a biased expected value 73. In a case of the middle, a value higher than the expected value of the range 72 is assumed to be a biased expected value 74. In a case of the expert, a biased expected value 75 is assumed to be the same as the expected value of the range 72. In the embodiment, as described above, by calculating the biased expected value, the novice, the middle, and the expert are expressed. That is, for example, as opposed to the normal simulation in which the expected value of the unsearched facility is used, in the embodiment, by using the biased expected value obtained by manipulating (correcting) the expected value instead of the expected value, the novice, the middle, and the expert are expressed.

Next, a configuration of the simulation apparatus 1 will be described. As illustrated in FIG. 1, the simulation apparatus 1 includes an input unit 10, an input information storage unit 20, a simulation management unit 30, a simulation execution unit 40, a simulation result output unit 50, and an agent information storage unit 60.

The input unit 10 receives input information relating to the simulation such as selection candidate information 11, experience information 12, layout information 13, and the like from an input device such as a mouse, a keyboard, and the like, for example.

The input information storage unit 20 stores input information such as the selection candidate information 11, the experience information 12, the layout information 13, and the like input from the input unit 10 in a storage device such as a random access memory (RAM), a hard disk drive (HDD), or the like.

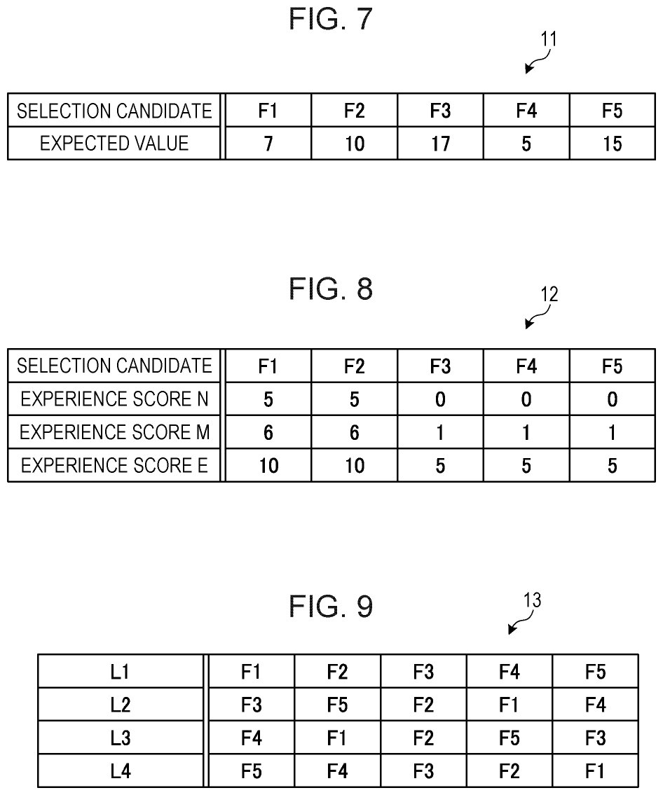

The selection candidate information 11 is information in which the selection candidate corresponding to the small facility in the facility and the expected value of each small facility are correspondent to each other. FIG. 7 is a diagram illustrating an example of the selection candidate information. The input unit 10 receives an input of the information, as illustrated in FIG. 7, in which a set of selection candidates are associated with expected values, respectively. In the set of selection candidates, the small facilities are expressed using identifiers (IDs) such as F1 or F2. The expected value expresses the predicted satisfaction level for the article, and has the average and the dispersion. Note that the example in FIG. 7 illustrates the expected values in a case of the dispersion 0 for the sake of simplicity.

The experience information 12 is information in which a selection candidate corresponding to each small facility in the facility and experience scores of the novice, the middle, and the expert for the small facility are correspondent to one another. The experience score is an index obtained by numerically expressing the experience value for the use of the facility, and is set for each agent. FIG. 8 is a diagram illustrating an example of the experience information. The input unit 10 receives an input of information, as illustrated in FIG. 8, in which a set of selection candidates are associated with the experience scores of the novice, the middle, and the expert for the respective selection candidates. An experience score N represents the experience score of the novice. An experience score M represents the experience score of the middle. An experience score E represents the experience score of the expert.

The layout information 13 is information indicating a layout of the small facilities in the facility, that is, for example, the visiting order of the agent. FIG. 9 is a diagram illustrating an example of the layout information. The input unit 10 receives an input of information, as illustrated in FIG. 9, on an order such as the small facilities F1, F2, F3, F4, and F5, for example, as a layout L1. In other words, for example, the layout L1 indicates that the agent visits the small facilities from the small facility F1 toward the small facility F5 in order. Note that the layout information 13 in FIG. 9 is layout information in a case where four layouts of the layouts L1 to L4 are received.

The simulation management unit 30 manages processing for simulating the searching action of the facility user executed by the simulation execution unit 40. That is, for example, the simulation management unit 30 and the simulation execution unit 40 execute the simulation in which the agent performs a checking action for checking the plurality of selection candidates for each of which the expected value is set in order.

The simulation management unit 30 reads, in accordance with progress of the simulation performed by the simulation execution unit 40, the input information stored in the input information storage unit 20, and the interim progress of the simulation stored in the agent information storage unit 60 (the biased expected value and the actual evaluated value with respect to each shop). The simulation management unit 30 outputs the read contents to the simulation execution unit 40. The simulation management unit 30 further outputs a result of the successive simulation of the user action by the simulation execution unit 40 to the simulation result output unit 50.

The simulation management unit 30 extracts one unchecked selection candidate (small facility) from the set of selection candidates, in accordance with the progress of the simulation, and outputs it to the simulation execution unit 40. The simulation management unit 30 determines the visit destination, by referring to the layout information 13, for example, based on the facility layout, and the preference for each small facility and the time restriction of the user. The simulation management unit 30 extracts the unchecked selection candidate which is the determined visit destination, and outputs it to the simulation execution unit 40.

When the determined selection candidate is stored in the agent information storage unit 60, by a selection unit 43, the simulation management unit 30 moves the agent to the determined selection candidate, and determines purchase at the small facility of the determined selection candidate. The simulation management unit 30 outputs information on the movement and a purchase result of the agent to the simulation result output unit 50.

The simulation execution unit 40 successively simulates the evaluated value when the facility user actually visits each small facility. Furthermore, the simulation execution unit 40 determines an action to be performed next by the user, based on the biased expected value and the actual evaluated value. For example, the simulation execution unit 40 determines whether to check the unchecked small facility or select one small facility among the checked small facilities. The simulation execution unit 40 outputs a result of the simulation to the simulation management unit 30.

The simulation execution unit 40 includes a calculation unit 41, a determination unit 42, and the selection unit 43.

The calculation unit 41 calculates the biased expected value and actual evaluated value of each small facility for the user (agent). The calculation unit 41 calculates the biased expected value for each selection candidate, by referring to the selection candidate information 11 and the experience information 12, based on the experience information 12. In a case where the experience score is small, the calculation unit 41 calculates the biased expected value such that the biased expected value<the expected value average is satisfied. The calculation unit 41 calculates the biased expected value so as to be 0, for example, for the small facility with the experience score of 0.

In a case where the experience score is medium, the calculation unit 41 calculates the biased expected value such that the biased expected value>the expected value average is satisfied. The calculation unit 41 calculates the biased expected value so as to be a value obtained by adding 5 to the expected value, for example, for the small facility with the experience score of more than 0 and less than 5. In a case where the experience score is large, the calculation unit 41 calculates the biased expected value such that the biased expected value=the expected value average is satisfied. The calculation unit 41 uses the expected value of the selection candidate information 11 as it is as the biased expected value, for example, for the small facility with the experience score of equal to or more than 5. Note that in a case where the expected value has the dispersion, the biased expected value has the corresponding dispersion value. The calculation unit 41 outputs the calculated biased expected value to the simulation result output unit 50 through the simulation management unit 30.

Note that the biased expected value may be calculated so as to reproduce a case where the information searching action of the user changes depending on a time period. For example, during daytime, the biased expected value of all the agents may be increased, that is, for example, the information search trajectory may be lengthened. After the lapse of a dinner time period, the biased expected value of all the agents may be decreased, that is, for example, the information search trajectory may be shortened. With this, it is possible to reproduce a change in the information searching action in accordance with the time period.

Furthermore, the biased expected value may be calculated so as to reproduce a case where the information searching action of the user changes depending on an attribute other than the use experience. For example, as the number of people (group) who act together decreases, the biased expected value may be increased, that is, for example, the information search trajectory may be lengthened, and as the number of people of the group increases, the biased expected value may be decreased, that is, for example, the information search trajectory is shortened. In the same manner, for example, in a case of a guest being alone, the biased expected value may be increased, that is, for example, the information search trajectory may be lengthened, and in a case of family guests, the biased expected value is decreased, that is, for example, the information search trajectory may be shortened. With this, a difference in the information searching action due to a group configuration may be reproduced.

The calculation unit 41 calculates the actual evaluated value for the selection candidate input from the simulation management unit 30. The calculation unit 41 assumes that the expected value follows a normal distribution, for example, and stochastically calculates the actual evaluated value based on the average and dispersion of the expected value. The calculation unit 41 outputs the calculated actual evaluated value to the simulation result output unit 50.

In other words, for example, based on the experience score set for the agent and the expected value of each of the plurality of selection candidates, the calculation unit 41 calculates the biased expected value of each of the plurality of selection candidates for the agent. The biased expected value of each of the plurality of selection candidates is calculated in accordance with the group configuration set for the agent. The biased expected value of each of the plurality of selection candidates is set based on the time period. In a case where the experience score set for the agent is relatively small, the calculation unit 41 calculates a value smaller than the expected value for each of the plurality of selection candidates as the biased expected value. In a case where the experience score set for the agent is relatively medium, the calculation unit 41 calculates a value larger than the expected value for each of the plurality of selection candidates as the biased expected value. In a case where the experience score set for the agent is relatively large, the calculation unit 41 calculates the expected value for each of the plurality of selection candidates as the biased expected value.

The determination unit 42 determines whether or not all the selection candidates (small facilities) are checked. In a case of determining that all the selection candidates are not checked, the determination unit 42 performs a continuation judgment of the checking action based on the actual evaluated value and the biased expected value. In other words, for example, the determination unit 42 determines whether or not to end the search of the small facility based on the actual evaluated value and the biased expected value. In the determination, when the actual evaluated value of the extracted selection candidate is higher than all the biased expected values and other all actual evaluated values, the determination unit 42 determines to end the search of the small facility. When there is the biased expected value equal to or more than the actual evaluated value of the extracted selection candidate, the determination unit 42 continues the search of the small facility. In a case of determining not to end the search of the small facility, the determination unit 42 instructs the simulation management unit 30 to extract a next unchecked selection candidate.

In a case of determining to end the search of the small facility, the determination unit 42 outputs a selection instruction to the selection unit 43. In a case of determining that all the selection candidates are checked as well, the determination unit 42 outputs the selection instruction to the selection unit 43.

In other words, for example, the determination unit 42 performs the continuation judgment of the checking action for each check of the selection candidate by the agent, based on the biased expected value of the unchecked selection candidate and the evaluated value of the checked selection candidate. In a case where a maximum value of the evaluated values of the checked selection candidates is larger than a maximum value of the expected values of the unchecked selection candidates, the determination unit 42 judges to end the checking action. In a case where a maximum value of the evaluated values of the checked selection candidates is smaller than a maximum value of the expected values of the unchecked selection candidates, the determination unit 42 judges to continue the checking action.

When the selection instruction is input from the determination unit 42, the selection unit 43 determines a selection candidate by referring to the agent information storage unit 60, based on the actual evaluated value. The selection unit 43 outputs the determined selection candidate to the simulation result output unit 50.

The simulation result output unit 50 stores the biased expected value, the actual evaluated value, the determined selection candidate, and information on the movement and the purchase result of the agent in the agent information storage unit 60. The simulation result output unit 50 displays the biased expected value, the actual evaluated value, the determined selection candidate, and the information on the movement and the purchase result of the agent, using a display device such as a monitor, or a printer. Note that the simulation result output unit 50 may successively output the result of the successive simulation. The simulation result output unit 50 may output a totalization result of the results obtained by the simulation over a predetermined time.

The agent information storage unit 60 stores the biased expected value, the actual evaluated value, the decided selection candidate, information on the movement and the purchase result of the agent, and the like obtained by the simulation, in the storage device such as the RAM, the HDD, or the like.

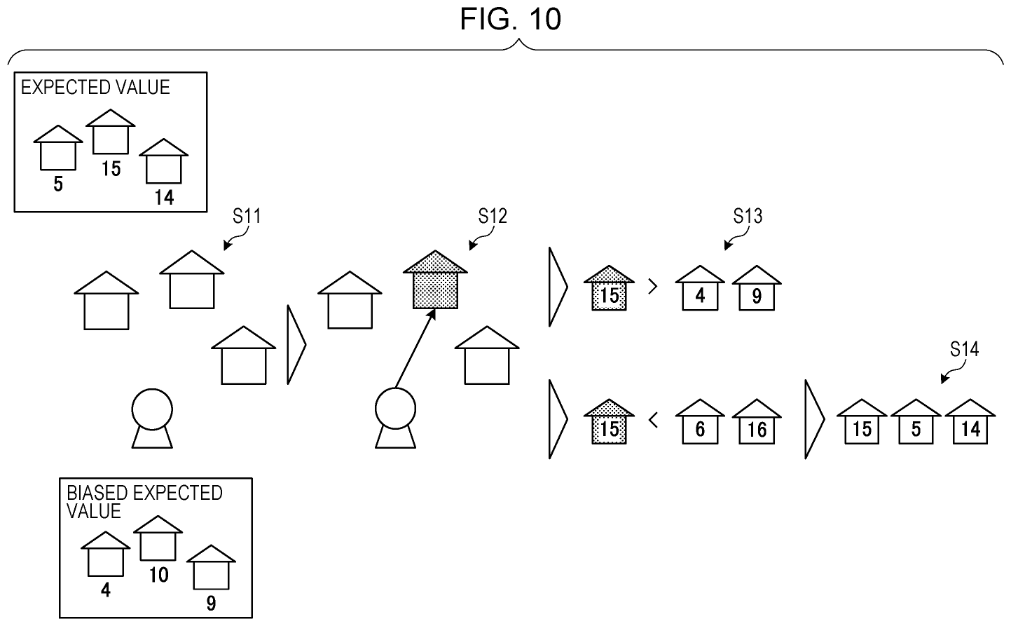

The searching action using the biased expected value will be described with reference to FIG. 10 to FIG. 13. FIG. 10 is a diagram illustrating an example of the searching action using the biased expected value and the actual evaluated value. As illustrated in FIG. 10, based on the selection candidate information 11 and the experience information 12, the simulation apparatus 1 sets the biased expected value of the article placed in each small facility (step S11).

The simulation apparatus 1 decides the visit destination, by referring to the layout information 13, from the facility layout, and the preference for the small facility and the time restriction of the user. The simulation management unit 30 extracts the unchecked selection candidate which is the decided visit destination, and calculates the actual evaluated value (step S12).

When there is the biased expected value equal to or more than the actual evaluated value of the extracted selection candidate, the simulation apparatus 1 returns to step S12, and continues the search of the small facility. On the other hand, when the actual evaluated value of the extracted selection candidate is higher than all the biased expected values and other all actual evaluated values, the simulation apparatus 1 determines to end the search of the small facility (step S13).

The simulation apparatus 1 decides the selection candidate based on the actual evaluated value. The simulation apparatus 1 moves the agent to the decided selection candidate, and decides a purchase at the small facility of the selection candidate (step S14). This makes it possible for the simulation apparatus 1 to simulate the action in which the user purchases the article at the small facility decided based on the biased expected value.

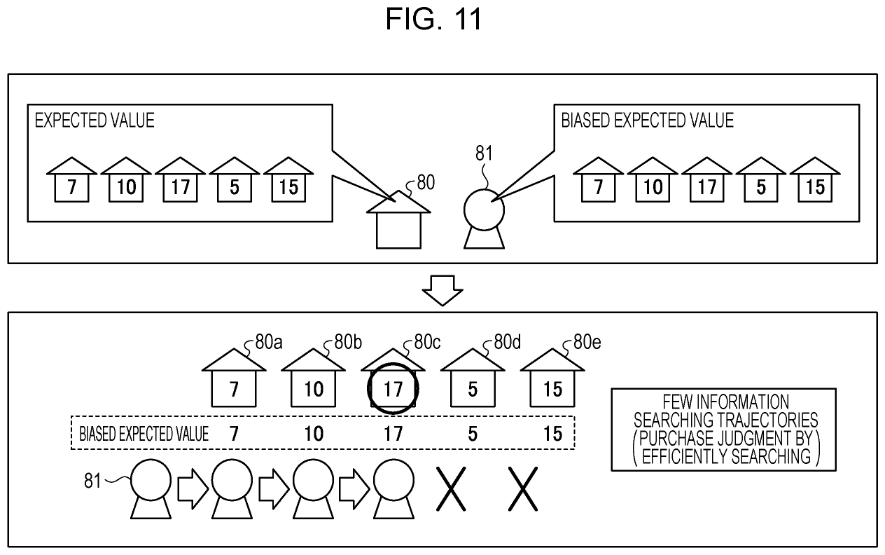

FIG. 11 is a diagram illustrating an example of the searching action in a case where the biased expected value is set for the expert. In FIG. 11, a case where an expert 81 being the agent acts based on the biased expected value for a facility 80 including a plurality of small facilities will be described. The biased expected value of the expert 81 is assumed to be the expected value average. Note that a case where the expected value is a fixed value (dispersion 0) will be described here.

In FIG. 11, in the order of small facilities 80a to 80e of the facility 80, the expected values are “7”, “10”, “17”, “5”, and “15”, respectively. In the same manner, the biased expected values of the expert 81 are “7”, “10”, “17”, “5”, and “15”, respectively. In a case of visiting the small facilities 80a to 80e in this order, the expert 81 determines to continue the search at the small facilities 80a and 80b, and decides the purchase at the small facility 80c. That is, for example, it is possible to reproduce that the expert 81 performs the purchase judgment by efficiently searching, and has the few information search trajectories.

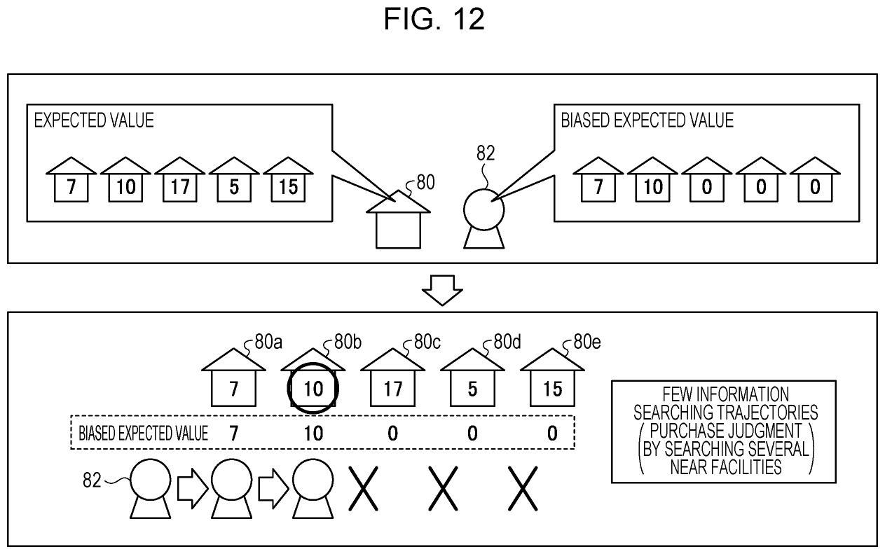

FIG. 12 is a diagram illustrating an example of the searching action in a case where the biased expected value is set for the novice. In FIG. 12, a case where a novice 82 being the agent acts based on the biased expected value for the facility 80 including the plurality of small facilities will be described. The biased expected value of the novice 82 is assumed to be “0” in a case where there is no use experience of the small facility. Note that a case where the expected value is a fixed value (dispersion 0) will be described here.

In FIG. 12, in the order of the small facilities 80a to 80e of the facility 80, the expected values are “7”, “10”, “17”, “5”, and “15”, respectively. In the order of the small facilities 80a to 80e, the biased expected values of the novice 82 are “7”, “10”, “0”, “0”, and “0”, respectively. In a case of visiting the small facilities 80a to 80e in this order, the novice 82 determines to continue the search at the small facility 80a, and decides the purchase at the small facility 80b. That is, for example, it is possible to reproduce that the novice 82 performs the purchase judgment by searching several near facilities, and has the few information search trajectories.

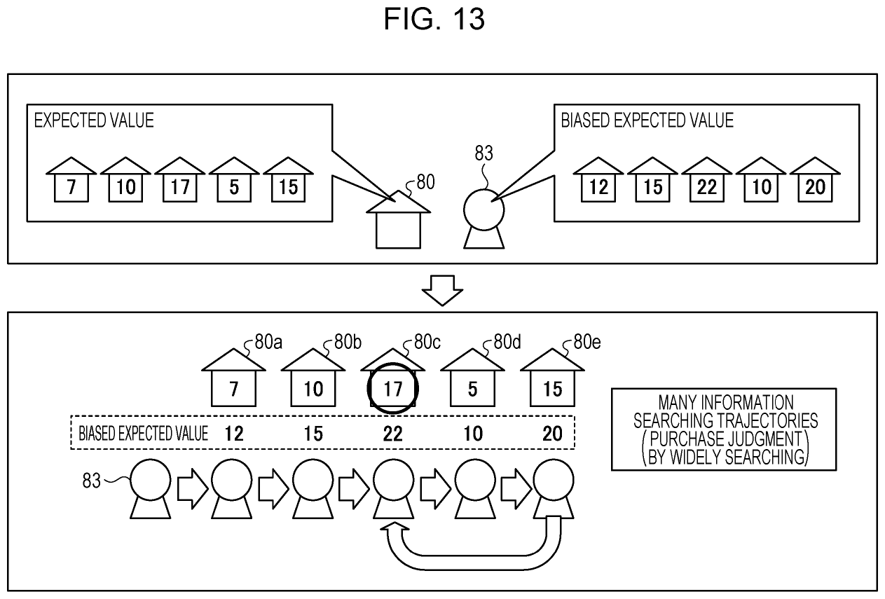

FIG. 13 is a diagram illustrating an example of the searching action in a case where the biased expected value is set for the middle. In FIG. 13, a case where a middle 83 being the agent acts based on the biased expected value for the facility 80 including the plurality of small facilities will be described. The biased expected value of the middle 83 is assumed to be larger than the expected value average. Note that a case where the expected value is a fixed value (dispersion 0) will be described here.

In FIG. 13, in the order of the small facilities 80a to 80e of the facility 80, the expected values are “7”, “10”, “17”, “5”, and “15”, respectively. In the order of the small facilities 80a to 80e, the biased expected values of the middle 83 are “12”, “15”, “22”, “10”, and “20”, respectively. In a case of visiting the small facilities 80a to 80e in this order, the middle 83 determines to continue the search at the small facilities 80a to 80d, returns to the small facility 80c after the search to the small facility 80e, and decides the purchase at the small facility 80c. That is, for example, it is possible to reproduce that the middle 83 performs the purchase judgment by widely searching, and has the many information search trajectories.

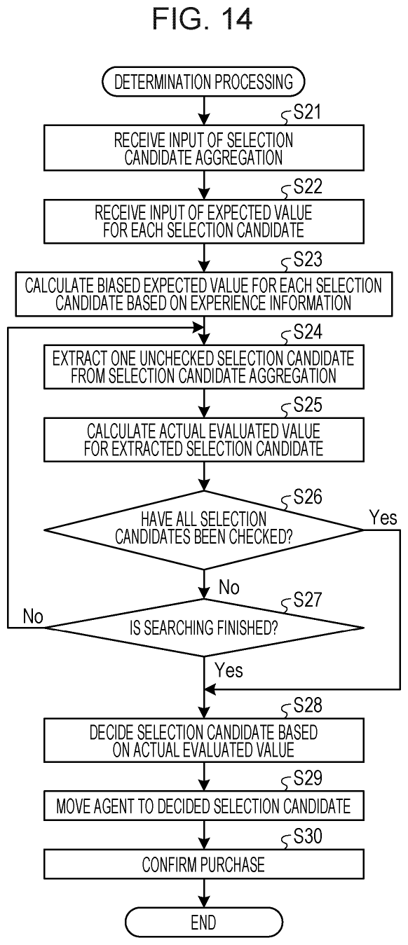

Next, operations of the simulation apparatus 1 of the first embodiment will be described. FIG. 14 is a flowchart illustrating an example of determination processing of the first embodiment.

When processing is started, the input unit 10 of the simulation apparatus 1 receives an input of the selection candidate information 11, that is, for example, a selection candidate aggregation indicating a group of selection candidates, and an input of the expected value for each selection candidate (steps S21 and S22). The input unit 10 receives inputs of the experience information 12 and the layout information 13, and stores them in the input information storage unit 20 with the selection candidate information 11.

The calculation unit 41 calculates the biased expected value for each selection candidate, by referring to the selection candidate information 11 and the experience information 12, based on the experience information 12, with respect to each of the novice, the middle, and the expert (step S23). The calculation unit 41 outputs the calculated biased expected value to the simulation result output unit 50 through the simulation management unit 30.

The simulation management unit 30 extracts one unchecked selection candidate from the selection candidate aggregation, in accordance with the progress of the simulation, and outputs it to the simulation execution unit 40 (step S24).

The calculation unit 41 moves the agent to the selection candidate input from the simulation management unit 30, that is, for example, the extracted selection candidate, and calculates the actual evaluated value (step S25). The calculation unit 41 outputs the calculated actual evaluated value to the simulation result output unit 50.

The determination unit 42 determines whether or not all the selection candidates are checked (step S26). In a case of determining that all the selection candidates are not checked (No in step S26), the determination unit 42 determines, based on the actual evaluated value and the biased expected value, whether or not to end the search of the small facility (step S27). In a case of determining not to end the search of the small facility (No in step S27), the determination unit 42 instructs the simulation management unit 30 to extract a next unchecked selection candidate, and the processing returns to step S24.

In a case of determining that all the selection candidates are checked (Yes in step S26), or in a case of determining that the search of the small facilities is ended (Yes in step S27), the determination unit 42 outputs the selection instruction to the selection unit 43.

When the selection instruction is input from the determination unit 42, the selection unit 43 decides the selection candidate by referring to the agent information storage unit 60 based on the actual evaluated value (step S28). The selection unit 43 outputs the decided selection candidate to the simulation result output unit 50.

The simulation management unit 30 moves the agent to the decided selection candidate (step S29). The simulation management unit 30 decides the purchase at the small facility being the selection candidate, and outputs the movement and purchase result of the agent to the simulation result output unit 50 (step S30). With this, the simulation apparatus 1 may reproduce the searching action in accordance with the user experience. The simulation apparatus 1 may reproduce the information searching action in accordance with the user experience with the same calculation resource as that of the simulation of the searching action illustrated in FIG. 2.

As described above, in the simulation apparatus 1, the agent sequentially performs the checking action for checking the plurality of selection candidates for each of which the expected value is set. Based on the experience score set for the agent and the expected value of each of the plurality of selection candidates, the simulation apparatus 1 calculates the biased expected value of each of the plurality of selection candidates for the agent. The simulation apparatus 1 performs the continuation judgment of the checking action for each check of the selection candidate by the agent, based on the biased expected value of the unchecked selection candidate and the evaluated value of the checked selection candidate. As a result, the simulation apparatus 1 may reproduce the searching action in accordance with the user experience.

In the simulation apparatus 1, the biased expected value of each of the plurality of selection candidates is calculated in accordance with the group configuration set for the agent. As a result, the simulation apparatus 1 may reproduce the difference in the information searching action due to the group configuration.

In the simulation apparatus 1, the biased expected value of each of the plurality of selection candidates is set based on the time period. As a result, the simulation apparatus 1 may reproduce the change in the information searching action due to the time period.

In the simulation apparatus 1, in a case where the experience score set for the agent is relatively small, a value smaller than the expected value is calculated for each of the plurality of selection candidates as the biased expected value. In the simulation apparatus 1, in a case where the experience score set for the agent is relatively medium, a value larger than the expected value is calculated for each of the plurality of selection candidates as the biased expected value. In the simulation apparatus 1, in a case where the experience score set for the agent is relatively large, the expected value is calculated for each of the plurality of selection candidates as the biased expected value. As a result, the simulation apparatus 1 may reproduce the searching action in accordance with the user experience.

In a case where a maximum value of the evaluated values of the checked selection candidates is larger than a maximum value of the expected values of the unchecked selection candidates, the simulation apparatus 1 judges to end the checking action. In a case where a maximum value of the evaluated values of the checked selection candidates is smaller than a maximum value of the expected values of the unchecked selection candidates, the simulation apparatus 1 judges to continue the checking action. As a result, the simulation apparatus 1 may reproduce the searching action in accordance with the user experience.

### Second Embodiment

Although, in the above-described first embodiment, the simulation with one visiting experience to the facility has been described, a simulation with a plurality of visiting experiences may be performed, and an embodiment of this case will be described as a second embodiment. Note that the same configurations as those of the simulation apparatus 1 of the first embodiment are given the same reference numerals, and redundant descriptions of configurations and operations thereof will be omitted.

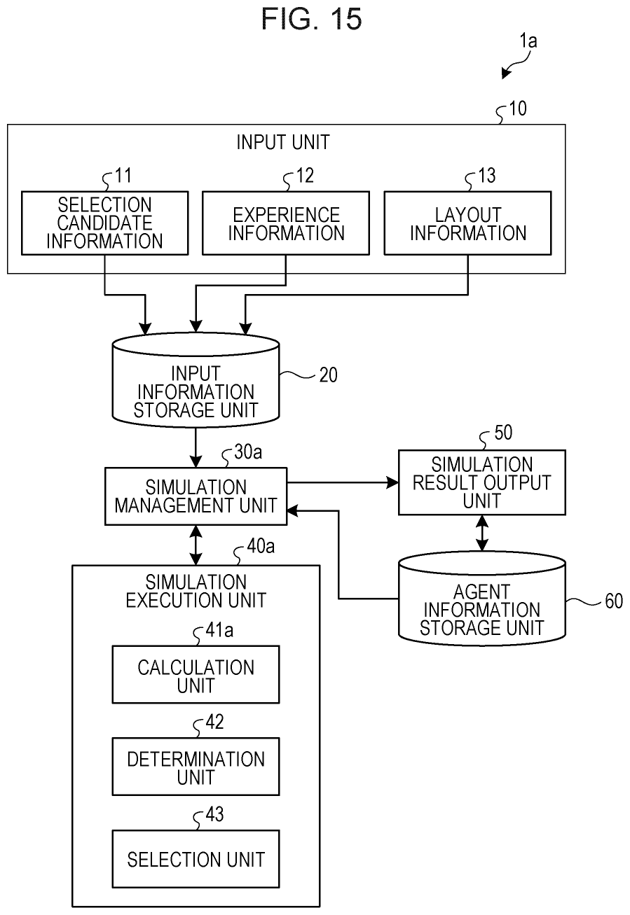

FIG. 15 is a block diagram illustrating an example of a functional configuration of a simulation apparatus according to the second embodiment. A simulation apparatus 1a illustrated in FIG. 15 includes a simulation management unit 30a and a simulation execution unit 40a, instead of the simulation management unit 30 and the simulation execution unit 40, as compared with the simulation apparatus 1 of the first embodiment. The simulation execution unit 40a includes a calculation unit 41a, instead of the calculation unit 41, as compared with the simulation execution unit 40 of the first embodiment.

The simulation management unit 30a further updates the experience information 12 stored in the input information storage unit 20, based on the simulation result, in comparison with the simulation management unit 30 of the first embodiment. The simulation management unit 30a outputs information on the movement and purchase result of the agent to the simulation result output unit 50, and then reflects on each experience score of the experience information 12 that the number of use times of the facility is increased by one. For example, in the facility 80 including the small facilities 80a to 80e, when the purchase is confirmed at any one among the small facilities 80a to 80e, the simulation management unit 30a increases the experience score of each of the small facilities 80a to 80e by “1”. Note that the update of the experience score may be performed so as to provide an experience score corresponding to the user and update the experience score of the user. When the update of the experience information 12 is finished, the simulation management unit 30a instructs the calculation unit 41a to calculate the biased expected value.

The calculation unit 41a further reproduces repeated use of the facility, by updating the biased expected value, based on the updated experience score, in comparison with the calculation unit 41. The calculation unit 41a calculates the biased expected value for each selection candidate, by referring to the selection candidate information 11 and the experience information 12, based on the expected value of the selection candidate information 11 and the experience information 12, with respect to each of the novice, the middle, and the expert. At this time, in the second and subsequent calculation of the biased expected value, the calculation unit 41a refers to the experience information 12 including the updated experience score. Note that the calculation of the biased expected value is the same as the calculation of the biased expected value of the first embodiment, and descriptions thereof will be omitted.

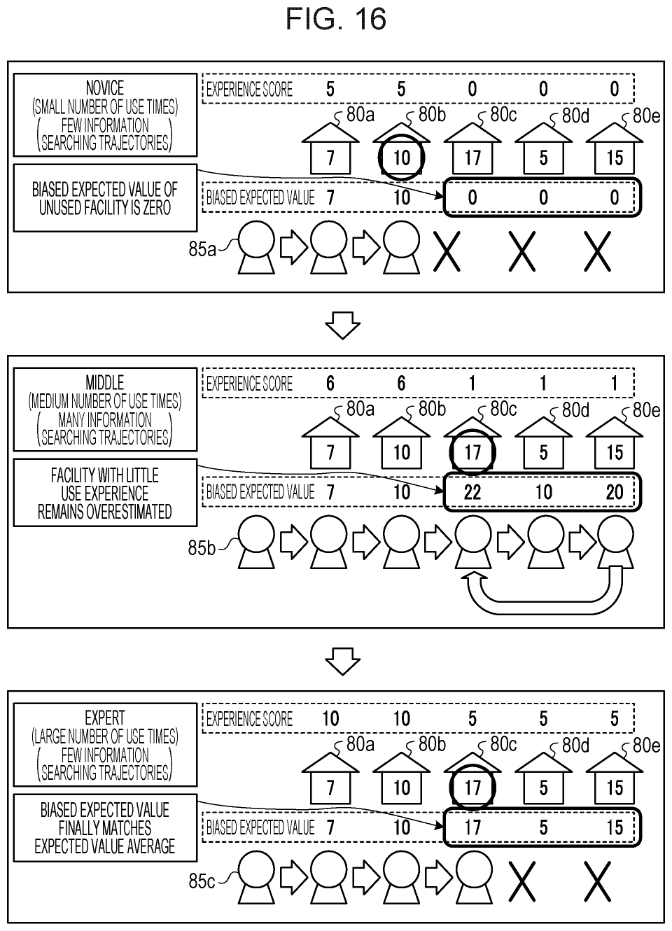

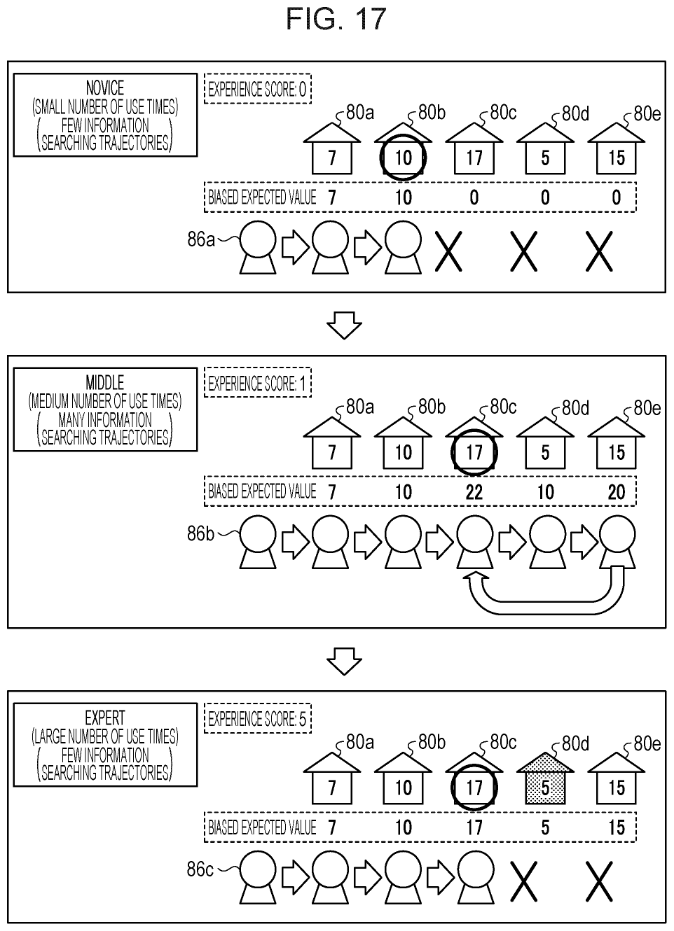

With reference to FIG. 16 and FIG. 17, a case where the biased expected value is changed will be described. FIG. 16 is a diagram illustrating an example in the case where the biased expected value is changed by the repeated use. FIG. 16 illustrates a case where the experience score of each of the small facilities 80a to 80e is updated in accordance with the number of use times. First, the user is assumed to be a novice 85a with little use experience of the facility 80.

In FIG. 16, in the order of the small facilities 80a to 80e, the expected values are “7”, “10”, “17”, “5”, and “15”, respectively. In the order of the small facilities 80a to 80e, the experience scores of the novice 85a are “5”, “5”, “0”, “0”, and “0”, respectively. In the order of the small facilities 80a to 80e, the biased expected values of the novice 85a are “7”, “10”, “0”, “0”, and “0”, respectively. That is, the biased expected value of the unused facility of the novice 85a is zero. In this case, in the same manner as the novice 82 of the first embodiment, the novice 85a decides the purchase at the small facility 80b. In other words, it is possible to reproduce that the novice 85a has the few information search trajectories.

Thereafter, the novice 85a forms overestimated biased expected values based on the use experience, information such as signage and a shop front advertisement in the facility, or the like, and changes to a middle 85b. The middle 85b is assumed to have the medium number of use times of the facility 80. The information such as the signage and the shop front advertisement in the facility is an example of guide information relating to the selection candidate presented to the agent.

In the order of the small facilities 80a to 80e, the experience scores of the middle 85b are “6”, “6”, “1”, “1”, and “1”, respectively. In the order of the small facilities 80a to 80e, the biased expected values of the middle 85b are “7”, “10”, “22”, “10”, and “20”, respectively. That is, the facilities for which the middle 85b has little use experience remains overestimated. In this case, in the same manner as the middle 83 of the first embodiment, the middle 85b returns to the small facility 80c after visiting the small facilities 80a to 80e in this order, and decides the purchase at the small facility 80c. In other words, it is possible to reproduce that the middle 85b has the many information search trajectories.

Furthermore, a deviation of the biased expected value from the expected value average decreases as the use experience increases, and the middle 85b finally forms the biased expected value matching the expected value average and changes to an expert 85c. The expert 85c is assumed to have the large number of use times of the facility 80.

In the order of the small facilities 80a to 80e, the experience scores of the expert 85c are “10”, “10”, “5”, “5”, and “5”, respectively. In the order of the small facilities 80a to 80e, the biased expected values of the expert 85c are “7”, “10”, “17”, “5”, and “15”, respectively. In this case, in the same manner as the expert 81 of the first embodiment, the expert 85c decides the purchase at the small facility 80c. In other words, it is possible to reproduce that the expert 85c has the few information search trajectories.

As described above, in the example in FIG. 16, the biased expected value of each of the plurality of selection candidates is set based on the number of visiting times of the agent for each selection candidate. The biased expected value of each of the plurality of selection candidates is set based on the guide information relating to the selection candidate presented to the agent in the simulation.

FIG. 17 is a diagram illustrating another example in the case where the biased expected value is changed by the repeated use. FIG. 17 illustrates a case where the experience score of the entire facility 80 including the small facilities 80a to 80e is updated in accordance with the number of use times. FIG. 17 illustrates an example of a case where a situation is reproduced in which if a certain facility is well known, the search of the entire facility including the unsearched small facilities may be well performed. In other words, in FIG. 17, the biased expected value is decided based on a skill level of the user. First, the user is assumed to be a novice 86a with little use experience of the facility 80.

In FIG. 17, in the order of the small facilities 80a to 80e, the expected values are “7”, “10”, “17”, “5”, and “15”, respectively. The experience score of the novice 86a with respect to the entire facility 80 is “0”. The experience score in this case may be, for example, the total number of use times of the small facilities 80a to 80e. It is assumed that, as the value of the experience score increases, the biased expected value of each of the small facilities 80a to 80e approaches the expected value average. In the order of the small facilities 80a to 80e, the biased expected values of the novice 86a are “7”, “10”, “0”, “0”, and “0”, respectively. In this case, in the same manner as the novice 82 of the first embodiment, the novice 86a decides the purchase at the small facility 80b. In other words, it is possible to reproduce that the novice 86a has the few information search trajectories.

Thereafter, the novice 86a forms overestimated biased expected values based on increase in the total number of use times of the small facilities 80a to 80e, and changes to a middle 86b. The middle 86b is assumed to have the medium number of use times of the facility 80.

The experience score of the middle 86b is “1”. In the order of the small facilities 80a to 80e, the biased expected values of the middle 86b are “7”, “10”, “22”, “10”, and “20”, respectively. In this case, in the same manner as the middle 83 of the first embodiment, the middle 86b returns to the small facility 80c after visiting the small facilities 80a to 80e in this order, and decides the purchase at the small facility 80c. In other words, it is possible to reproduce that the middle 86b has the many information search trajectories.

Furthermore, with increase in the total number of use times of the small facilities 80a to 80e, a deviation of the biased expected value from the expected value average decreases, and the middle 86b finally forms the biased expected value matching the expected value average and changes to an expert 86c. The expert 86c is assumed to have the large number of use times of the facility 80.

The experience score of the expert 86c is “5”. In the order of the small facilities 80a to 80e, the biased expected values of the expert 86c are “7”, “10”, “17”, “5”, and “15”, respectively. In this case, in the same manner as the expert 81 of the first embodiment, the expert 86c decides the purchase at the small facility 80c. In other words, it is possible to reproduce that the expert 86c has the few information search trajectories. In the example in FIG. 17, even if the number of visiting times of the small facility 80d is one and the number of visiting times of the small facilities 80a to 80c and 80e is five, it is possible to generate the biased expected value of the small facility 80d with the same accuracy as the small facilities 80a to 80c and 80e. In other words, in the example in FIG. 17, it is possible to reproduce the situation in which the search may be well performed including the small facility 80d with few visiting experiences by well knowing the entire facility 80.

As described above, in the example in FIG. 17, the biased expected value of each of the plurality of selection candidates is calculated in accordance with the skill level set for the agent.

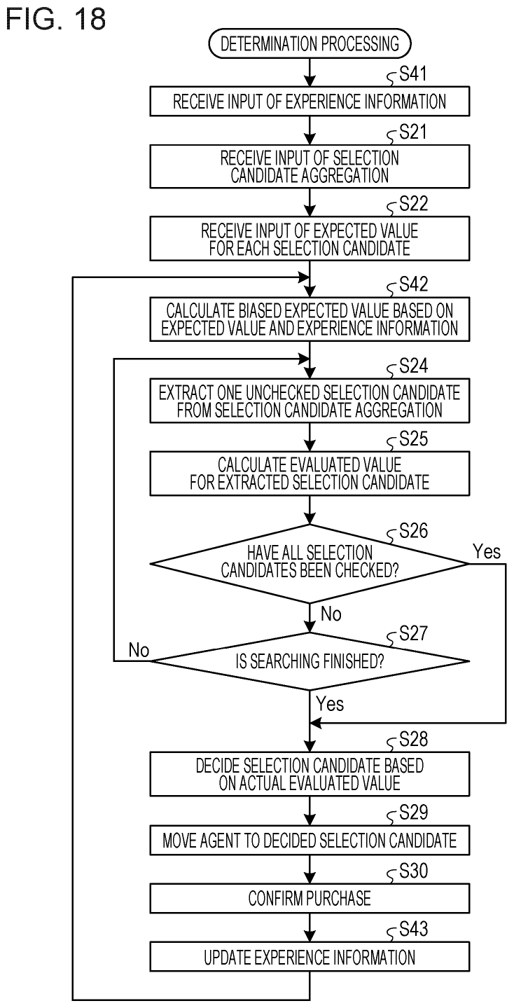

Next, operations of the simulation apparatus 1a of the second embodiment will be described. FIG. 18 is a flowchart illustrating an example of determination processing of the second embodiment. In the following descriptions, the processing in steps S21, S22, and S24 to S30 of the determination processing is the same as that in the first embodiment, and therefore the descriptions thereof will be omitted.

When the processing is started, the input unit 10 of the simulation apparatus 1 receives an input of the experience information 12 (step S41). The input unit 10 stores the received experience information 12 in the input information storage unit 20, and the processing proceeds to step S21.

The calculation unit 41a executes processing described below following step S22. The calculation unit 41a calculates the biased expected value for each selection candidate, by referring to the selection candidate information 11 and the experience information 12, based on the expected value of the selection candidate information 11 and the experience information 12, with respect to each of the novice, the middle, and the expert (step S42). The calculation unit 41a outputs the calculated biased expected value to the simulation result output unit 50 through the simulation management unit 30, and the processing proceeds to step S24.

The simulation management unit 30a executes processing described below following step S30. The simulation management unit 30a reflects on each experience score of the experience information 12 that the number of use times of the facility is increased by one, and updates the experience information 12 (step S43). When the update of the experience information 12 is finished, the simulation management unit 30a instructs the calculation unit 41a to calculate the biased expected value, and the processing returns to step S43. With this, the simulation apparatus 1a may reproduce the searching action in accordance with the user experience by the repeated use.

As described above, in the simulation apparatus 1a, the biased expected value of each of the plurality of selection candidates is set based on the number of visiting times of the agent for each selection candidate. As a result, the simulation apparatus 1a may reproduce the searching action in accordance with the number of use times of the small facility of the user.

In the simulation apparatus 1a, the biased expected value of each of the plurality of selection candidates is calculated in accordance with the skill level set for the agent. As a result, the simulation apparatus 1a may reproduce the searching action in accordance with the number of use times of the entire facility of the user.

In the simulation apparatus 1a, the biased expected value of each of the plurality of selection candidates is set based on the guide information relating to the selection candidate presented to the agent in the simulation. As a result, the simulation apparatus 1a may reproduce the searching action reflecting the information such as the signage and the shop front advertisement in the facility.

### Third Embodiment

Although, in the above-described second embodiment, the simulation with the plurality of visiting experiences to the facility has been described, a simulation in a case where the biased expected value changes during one visiting experience may be performed, an embodiment of this case will be described as a third embodiment. Note that the same configurations as those of the simulation apparatus 1 of the first embodiment are given the same reference numerals, and redundant descriptions of configurations and operations thereof will be omitted.

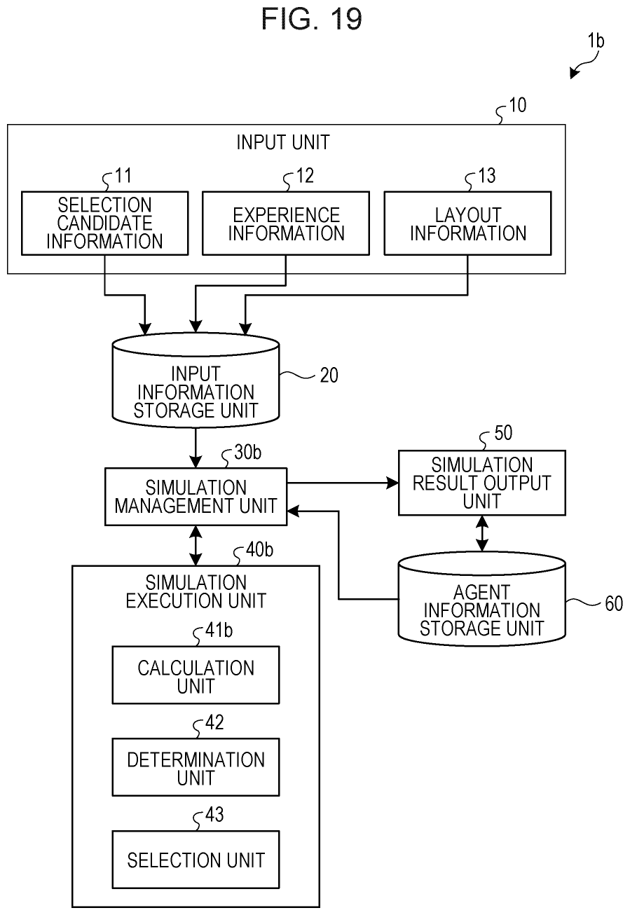

FIG. 19 is a block diagram illustrating an example of a functional configuration of a simulation apparatus according to the third embodiment. A simulation apparatus 1b illustrated in FIG. 19 includes a simulation management unit 30b and a simulation execution unit 40b, instead of the simulation management unit 30 and the simulation execution unit 40, as compared with the simulation apparatus 1 of the first embodiment. The simulation execution unit 40b includes a calculation unit 41b, instead of the calculation unit 41, as compared with the simulation execution unit 40 of the first embodiment.

The simulation management unit 30b further updates the biased expected value in a case where the experience score changes during the user moving around the facility in comparison with the simulation management unit 30 of the first embodiment. After outputting the unchecked selection candidate extracted from the selection candidate aggregation to the simulation execution unit 40, the simulation management unit 30b determines whether or not the experience score of the experience information 12 stored in the input information storage unit 20 changes during the user moving around the facility. In a case of determining that the experience score changes, the simulation management unit 30b instructs the calculation unit 41b to calculate the biased expected value.

The simulation management unit 30b changes the experience score during the user moving around the facility in accordance with a simulation condition. The simulation management unit 30b updates the experience information 12 stored in the input information storage unit 20 based on the changed experience score.

A case where the experience score changes during the user moving around the facility will be described. When information is acquired, the information search changes in some cases. In this case, for example, in a case where the guide information displayed on the signage or the like at the shop front is visually recognized, when the guide information is correct, the biased expected value of the small facility is brought close to the expected value average. In a case where the guide information is a misleading advertisement, the biased expected value of the small facility is increased. With this, an effect of the information presentation is reproduced.

Next, in accordance with remaining time, the information search trajectory changes in some cases. For example, by increasing the biased expected values of all the small facilities as the remaining time increases, it is reproduced that the information search is deeply performed. For example, by decreasing the biased expected values of all the small facilities as the remaining time decreases, it is reproduced that the information search is shallowly performed. For example, when the remaining time becomes zero, the biased expected values of all the small facilities are set to zero, thereby reproducing discontinuance of the information search. With this, it is possible to reproduce a change in the information searching action in accordance with the change in the remaining time.

Furthermore, in accordance with a fatigue state of the user, the information search trajectory changes in some cases. For example, by increasing the biased expected values of all the small facilities as a search total distance decreases, it is reproduced that the information search is deeply performed. For example, by decreasing the biased expected values of all the small facilities as the search total distance increases, it is reproduced that the information search is shallowly performed. For example, when the search total distance exceeds a certain threshold indicating a limit value of patience with the fatigue, the biased expected values of all the small facilities are set to zero, thereby reproducing discontinuance of the information search. With this, it is possible to reproduce a change in the information searching action in accordance with the fatigue.

The calculation unit 41b further reproduces the change in the information searching action due to the information presentation, the remaining time, the fatigue, and the like, by updating the biased expected value based on the updated experience score, in comparison with the calculation unit 41. When being instructed by the simulation management unit 30b to calculate the biased expected value, the calculation unit 41b calculates the biased expected value for each selection candidate, by referring to the selection candidate information 11 and the experience information 12, based on the expected value of the selection candidate information 11 and the experience information 12. Note that the biased expected value is calculated for each of the novice, the middle, and the expert. At this time, in the second and subsequent calculation of the biased expected value, the calculation unit 41b refers to the experience information 12 including the updated experience score. Note that the calculation of the biased expected value is the same as the calculation of the biased expected value of the first embodiment, and descriptions thereof will be omitted.

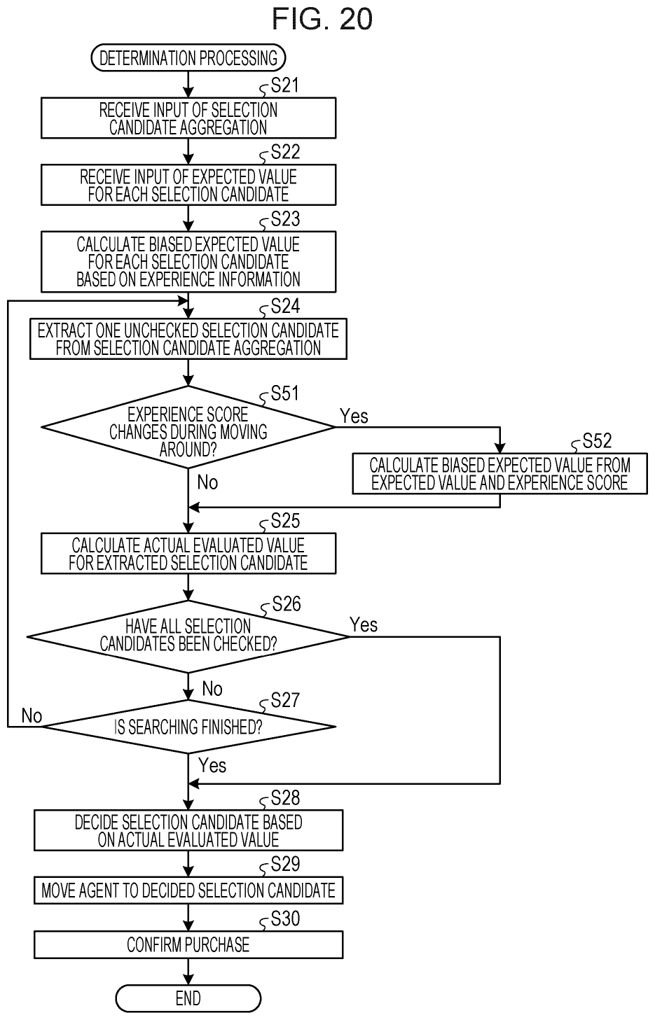

Next, operations of the simulation apparatus 1b of the third embodiment will be described. FIG. 20 is a flowchart illustrating an example of determination processing of the third embodiment. In the following descriptions, the processing in steps S21 to S24 and S25 to S30 of the determination processing is the same as that in the first embodiment, and therefore the descriptions thereof will be omitted.

The simulation management unit 30b executes processing described below following step S24. The simulation management unit 30b determines whether or not the experience score changes (step S51). In a case of determining that the experience score changes (Yes in step S51), the simulation management unit 30b instructs the calculation unit 41b to calculate the biased expected value.

When being instructed by the simulation management unit 30b to calculate the biased expected value, the calculation unit 41b calculates the biased expected value from the expected value of the selection candidate information 11 and the updated experience score of the experience information 12 (step S52), and the processing proceeds to step S25.

On the other hand, in a case of determining that the experience score does not changes (No in step S51), the simulation management unit 30b does not perform the calculation of the biased expected value, and the processing proceeds to step S25. With this, the simulation apparatus 1b may reproduce the searching action in a case where the biased expected value changes during one visiting experience.

### Fourth Embodiment

Although, in the above-described first embodiment, the simulation with one visiting experience to the facility has been described, evaluation of a layout design may be further performed, and an embodiment of this case will be described as a fourth embodiment. Note that the same configurations as those of the simulation apparatus 1 of the first embodiment are given the same reference numerals, and redundant descriptions of configurations and operations thereof will be omitted.

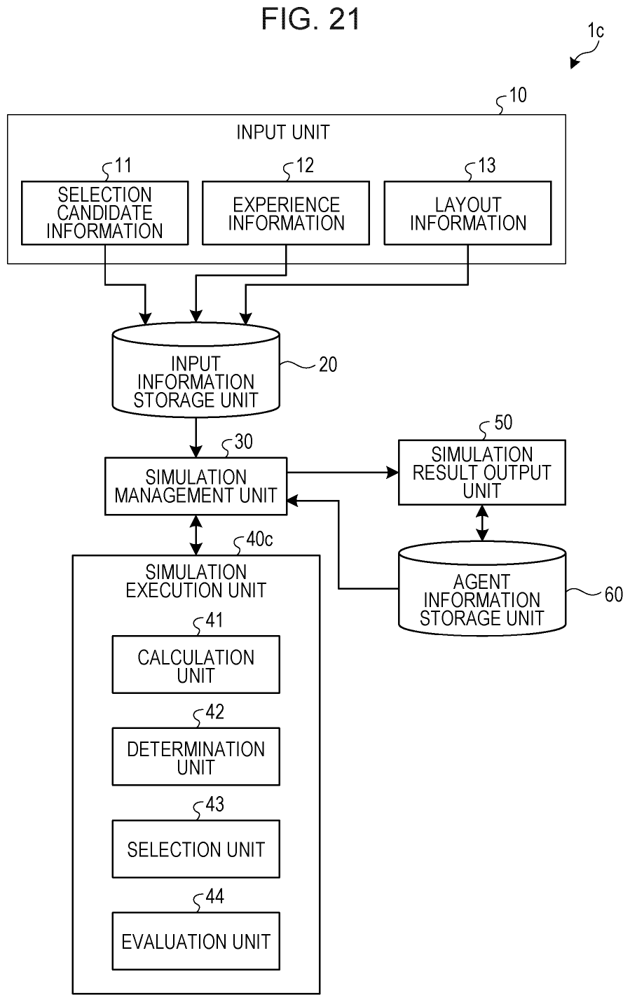

FIG. 21 is a block diagram illustrating an example of a functional configuration of a simulation apparatus according to the fourth embodiment. A simulation apparatus 1c illustrated in FIG. 21 includes a simulation execution unit 40c instead of the simulation execution unit 40 as compared with the simulation apparatus 1 of the first embodiment. The simulation execution unit 40c further includes an evaluation unit 44 as compared with the simulation execution unit 40 of the first embodiment. Note that in the simulation apparatus 1c, it is assumed that the simulation is executed for all the layouts L1 to L4 in the layout information 13.

The evaluation unit 44 acquires the biased expected value and the actual evaluated value of each agent (the novice, the middle, and the expert) in each small facility from the agent information storage unit 60 through the simulation management unit 30, with respect to the each of the layouts L1 to L4. The evaluation unit 44 acquires the expected value of the selection candidate information 11 stored in the input information storage unit 20 through the simulation management unit 30.

The evaluation unit 44 obtains a quality (q) of the selected small facility and a search cost (c) based on the ID and the expected value (EV) of the small facility and the biased expected value (BEV) and the actual evaluated value (V) of each agent. The evaluation unit 44 obtains a satisfaction level (s) based on the quality (q) of the selected small facility and the search cost (c).

The quality (q) of the selected small facility corresponds to the actual evaluated value (V) of the small facility at which the purchase judgment is made by each agent. The search cost (c) is obtained by adding a negative sign to the number of small facilities for which the search is performed by each agent. The satisfaction level (s) is calculated using the following equation (1).

Satisfaction level (s)=w1×q+w2×c (1)

Here, w1 and w2 indicate relative weight coefficients of the quality (q) of the selected small facility and the search cost (c), and changes depending on a property of the agent and a property of the small facility. Note that in the following descriptions, the satisfaction level (s) is calculated as w1=1 and w2=1.

After calculating the satisfaction level (s), the evaluation unit 44 calculates a satisfaction level gap using a Gini coefficient. Considering a user aggregation U, the satisfaction level of a user i∈U is taken as si, the satisfaction level of a user j∈U is taken as sj. Note that i≠j is satisfied. An average satisfaction level of the user aggregation U is taken as \hat{ }s, the satisfaction level gap may be calculated using the following equation (2).

(G)=ΣᵢΣⱼ|sᵢ−sⱼ/2ŝ (2)

Note that G is a real number of “0” to “1”, the gap decreases as the value approaches “0”, and the gap increases as the value approaches “1”.

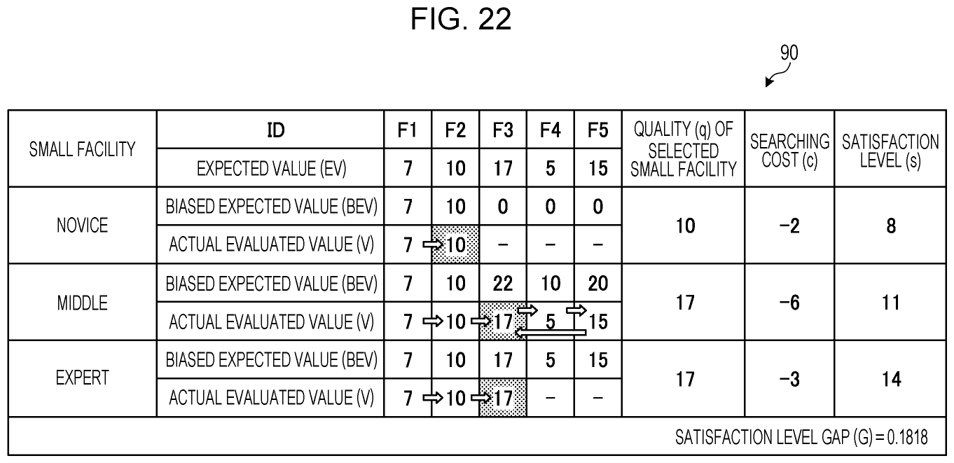

With reference to FIG. 22, calculation of the satisfaction level and the satisfaction level gap will be described. FIG. 22 is a diagram illustrating an example of the calculation of the satisfaction level and the satisfaction level gap. As illustrated in a table 90 in FIG. 22, in a case where the expected values (EV) of the small facilities F1, F2, F3, F4, and F5 are “7”, “10”, “17”, “5”, and “15”, respectively, since the novice selects the small facility F2, the quality (q) of the selected small facility is “10”. The search cost (c) is “−2”. Since the middle selects the small facility F3, the quality (q) of the selected small facility is “17”, and the search cost (c) is “−6”. Since the expert selects the small facility F3, the quality (q) of the selected small facility is “17”, and the search cost (c) is “−3”. Accordingly, the satisfaction levels (s) are “8” in the novice, “11” in the middle, and “14” in the expert, and the satisfaction level gap (G) is “0.1818”. As described above, the evaluation unit 44 evaluates the satisfaction levels and the satisfaction level gap of various users.

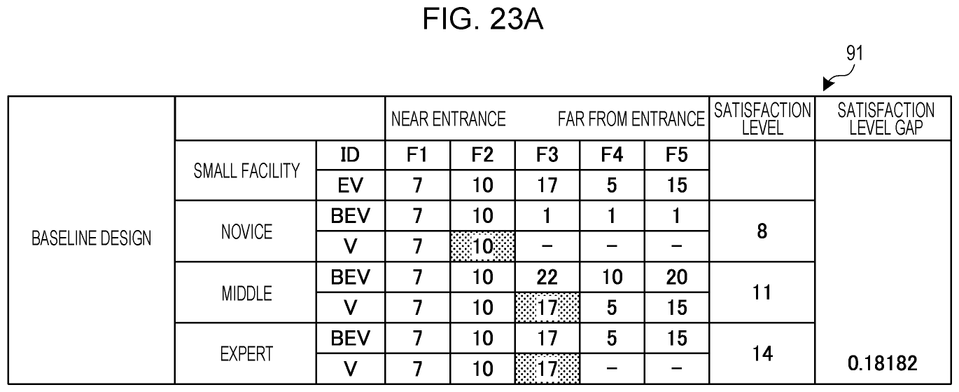

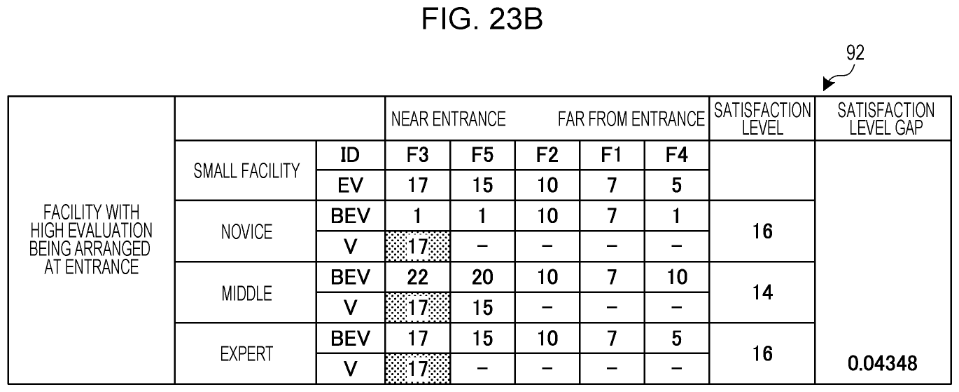

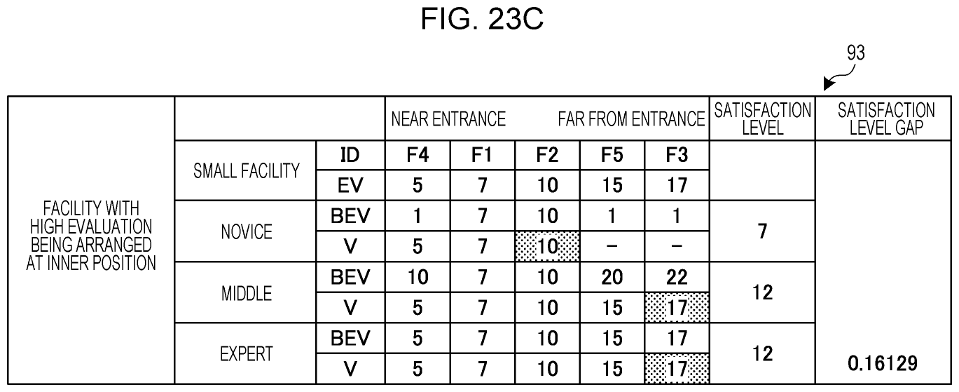

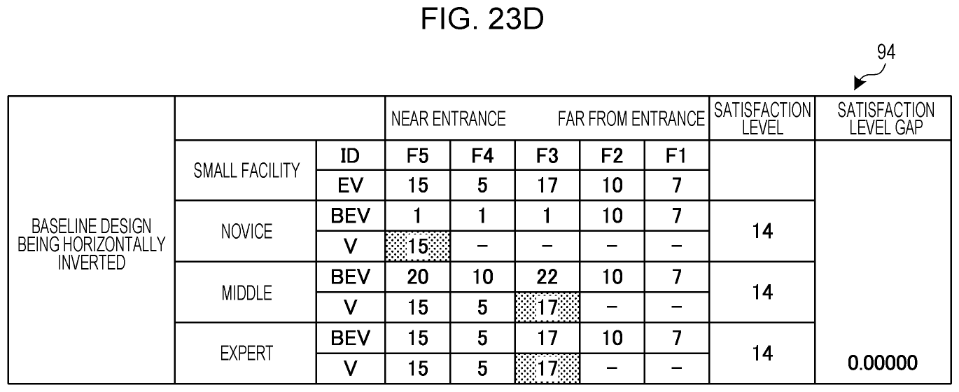

Next, with reference to FIGS. 23A to 23D, evaluation of a layout design will be described. FIGS. 23A to 23D are diagrams each illustrating an example of the evaluation of the layout design. A table 91 in FIG. 23A illustrates the satisfaction level and the satisfaction level gap in a case of a baseline design in which the small facilities are arranged in the order of F1, F2, F3, F4, and F5 from an entrance side toward an inner side. A table 92 in FIG. 23B illustrates the satisfaction level and the satisfaction level gap in a case where the small facilities are arranged in the order of F3, F5, F2, F1, and F4, which is a descending order of the evaluation of the facility, from the entrance side toward the inner side. A table 93 in FIG. 23C illustrates the satisfaction level and the satisfaction level gap in a case where the small facilities are arranged in the order of F4, F1, F2, F5, and F3, that is, for example, the small facilities are arranged in a descending order of the evaluation of the facility from the inner side toward the entrance side. A table 94 in FIG. 23D illustrates the satisfaction level and the satisfaction level gap in a case where the small facilities are arranged in the order of F5, F4, F3, F2, and F1 by horizontally inverting the baseline design. As illustrated in the table 91 to the table 94, the evaluation unit 44 evaluates that the case where the baseline design is horizontally inverted is the layout with the minimum satisfaction level gap.

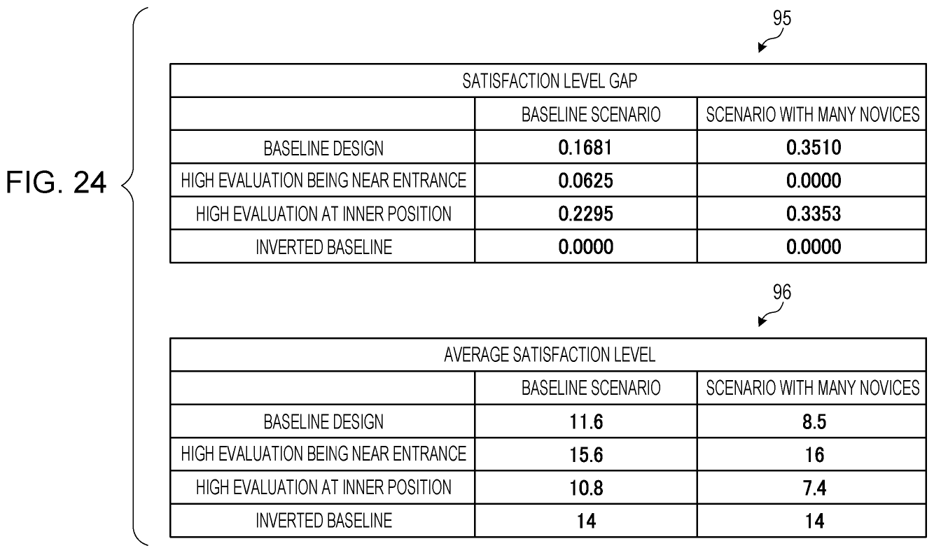

Subsequently, with reference to FIG. 24, comparison of a user scenario will be described. FIG. 24 is a diagram illustrating an example of the comparison of the user scenario. FIG. 24 illustrates the comparison of the satisfaction level gap and the average satisfaction level for a baseline scenario and a scenario with many novices as the user scenario. The baseline scenario is a scenario, for example, assuming a normal holiday, and is assumed to include 10 novices, 15 middles, and 20 experts. The scenario with many novices is a scenario, for example, assuming a bargain sale season during long consecutive holidays or the year-end and New Year holidays, and assumed to include 100 novices, 0 middles, and 10 experts.

As the layout, four layouts of the baseline design, the facility with the high evaluation being arranged at the entrance, the facility with the high evaluation being arranged at the inner position, and the baseline design being horizontally inverted in FIGS. 23A to 23D are used. Note that in FIG. 24, the layouts are indicated as the baseline design, the high evaluation near the entrance, the high evaluation at the inner position, and the inverted baseline, respectively.

A table 95 in FIG. 24 illustrates comparison of the baseline scenario and the scenario with many novices for the satisfaction level gap. In the table 95, the satisfaction level gap of the inverted baseline of the baseline scenario and the high evaluation near the entrance and the inverted baseline of the scenario with many novices is the minimum satisfaction level gap of “0.0000”. In this case, in the baseline scenario, the evaluation unit 44 may evaluate that the inverted baseline layout with the minimum satisfaction level gap is good. On the other hand, in the scenario with many novices, the evaluation unit 44 may not evaluate which layout of the high evaluation near the entrance layout and the inverted baseline layout is better.

Accordingly, for the scenario with many novices, as illustrated in a table 96, the average satisfaction levels are compared. The high evaluation near the entrance layout of the scenario with many novices has the average satisfaction level of “16”, the inverted baseline layout has the average satisfaction level of “14”. Accordingly, in the scenario with many novices, the evaluation unit 44 may evaluate that the high evaluation near the entrance layout is good. As described above, the evaluation unit 44 may evaluate the quality of the layout measure for each scenario.

That is, for example, in the layout design, the simulation apparatus 1c may evaluate whether the users with various types of use experience may each select a good article without a useless information search. The simulation apparatus 1c may also evaluate whether the layout design does not reduce the satisfaction level of the various users.

As described above, the simulation apparatus 1c evaluates the plurality of layouts of the plurality of selection candidates using the result of the continuation judgment of the checking action. As a result, the simulation apparatus 1c may evaluate the layout of the small facilities in the facility.

Each constituent element of each illustrated unit is not required to be physically configured as illustrated in the drawings. That is, for example, specific forms of dispersion and integration of the units are not limited to those illustrated in the drawings, and all or part of thereof may be configured by being functionally or physically dispersed or integrated in arbitrary units according to various loads, the state of use, and the like. For example, the determination unit 42 and the selection unit 43 may be integrated. The respective pieces of processing illustrated in the diagram are not limited to be performed in the above-described order, may be simultaneously performed within the range in which the processing contents are not inconsistent with one another, or may be performed in an interchanged order.

Note that all or any part of the various processing functions performed by the simulation apparatuses 1, 1a, 1b, and 1c according to the above-described embodiments may be executed on a CPU (or a microcomputer such as an MPU, a micro controller unit (MCU), or the like). It goes without saying that all or any part of the various processing functions may be executed on a program analyzed and executed by the CPU (or the microcomputer such as the MPU, the MCU, or the like) or on a hardware by wired logic.

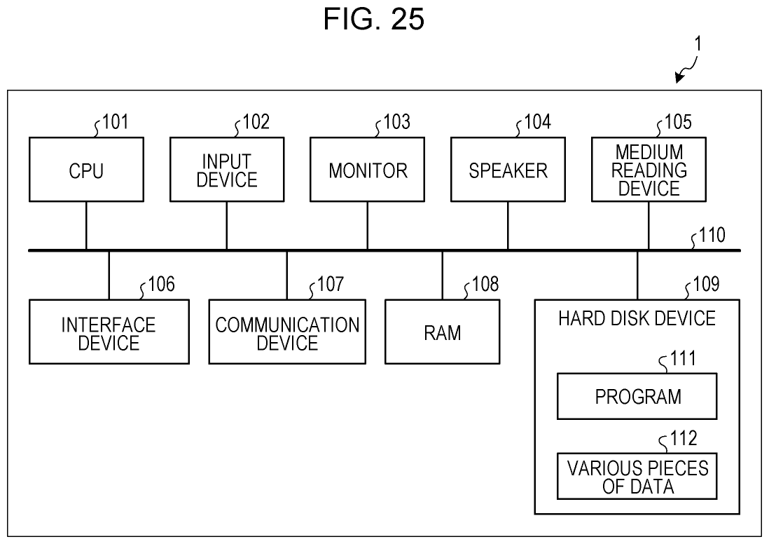

The various types of processing described in the above embodiments may be achieved by executing a program prepared beforehand with a computer. An example of a computer (hardware) which executes a program having the same function as those of the above-described embodiments will be described below. FIG. 25 is a block diagram illustrating an example of a hardware configuration of the simulation apparatus according to each of the embodiments. Note that in FIG. 25, although the simulation apparatus 1 is described as an example, the same applies to the simulation apparatuses 1a, 1b, and 1c.

As illustrated in FIG. 25, the simulation apparatus 1 includes a CPU 101 for executing various types of arithmetic processing, an input device 102 for receiving a data input, a monitor 103, and a speaker 104. The simulation apparatus 1 includes a medium reading device 105 for reading a program or the like from a storage medium, an interface device 106 for connection with various devices, and a communication device 107 for communication connection with external devices by wire or wireless. The simulation apparatus 1 includes an RAM 108 for temporarily storing various types of information, and a hard disk device 109. The respective sections (101 to 109) in the simulation apparatus 1 are connected to a bus 110.

In the hard disk device 109, a program 111 for executing the various types of processing described in the above embodiments is stored. In the hard disk device 109, various pieces of data 112 to which the program 111 refers are stored. The input device 102 receives, for example, an input of operation information from an operator of the simulation apparatus 1. On the monitor 103, for example, various screens on which the operator performs operation are displayed. To the interface device 106, for example, a printing device or the like is connected. The communication device 107 is connected to a communication network such as a local area network (LAN) or the like, and exchanges various types of information with the external devices through the communication network.

The CPU 101 performs the various types of processing by reading the program 111 stored in the hard disk device 109 and deploying and executing on the RAM 108. Note that the program 111 may not be stored in the hard disk device 109. For example, the program 111 stored in a storage medium readable by the simulation apparatus 1 may be read and executed by the simulation apparatus 1. For example, a portable recording medium such as a CD-ROM, a DVD disk, a Universal Serial Bus (USB) memory, or the like, a semiconductor memory such as a flash memory or the like, a hard disk drive, or the like corresponds to the storage medium readable by the simulation apparatus 1. This program may be stored in a device connected to a public line, the internet, the LAN, or the like, and the simulation apparatus 1 may read the program therefrom and execute.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a simulation process for performing checking action of checking, by an agent, a plurality of selection candidates in order for which expected values are set, the simulation process comprising:
calculating, for the agent, a biased expected value of each of the plurality of selection candidates, based on an experience score set for the agent and the expected value of each of the plurality of selection candidates; and
upon checking each of the plurality of selection candidates for the agent, performing a continuation judgment of determining whether the checking action is to be performed for a next one of the plurality of selection candidates, based on evaluated values set to checked selection candidates for which the checking action has been performed and the calculated biased expected values of unchecked selection candidates for which the checking action has not been performed yet.

2. The non-transitory, computer-readable recording medium of claim 1, wherein the biased expected value is set to each of the plurality of selection candidates, based on a number of times the agent has performed the checking action for each of the plurality of selection candidates.

3. The non-transitory, computer-readable recording medium of claim 1, wherein the biased expected value set to each of the plurality of selection candidates is calculated in accordance with a skill level set for the agent.

4. The non-transitory, computer-readable recording medium of claim 1, wherein the biased expected value of each of the plurality of selection candidates is set based on guide information that is related to the selection candidate and has been presented to the agent in a simulation.

5. The non-transitory, computer-readable recording medium of claim 1, wherein the biased expected value set to each of the plurality of selection candidates is calculated in accordance with a group configuration set for the agent.

6. The non-transitory, computer-readable recording medium of claim 1, wherein the biased expected value is set to each of the plurality of selection candidates, based on a time period during which the checking action is performed.

7. The non-transitory, computer-readable recording medium of claim 1, the simulation process further comprising:
evaluating a plurality of layouts each indicating a layout of the plurality of selection candidates, using a result of the continuation judgment performed for each of the plurality of selection candidates.

8. The non-transitory, computer-readable recording medium of claim 1, wherein:
a first score value, a second score value, and a third score value are set as the experience score for the agent such that the first score value is smaller than the second score value and the second score value is smaller than the third score value;
when the first score value is set as the experience score for the agent, a value smaller than the expected value is calculated as the biased expected value for each of the plurality of selection candidates;
when the second score value is set as the experience score for the agent, a value larger than the expected value is calculated as the biased expected value for each of the plurality of selection candidates; and
when the third score value is set as the experience score for the agent, the expected value is calculated as the biased expected value for each of the plurality of selection candidates.

9. The non-transitory, computer-readable recording medium of claim 1, wherein, in the continuation judgment:
the checking action is determined to be ended when a first maximum value indicating a maximum value among the evaluated values of selection candidates that have been already checked is larger than a second maximum value indicating a maximum value among the expected values of selection candidates that are not checked yet; and
the checking action is determined to be continued when the first maximum value is smaller than the second maximum value.

10. A method for simulating an agent performing a checking action that sequentially checks a plurality of selection candidates for each of which an expected value is set, the method comprising:
calculating, for the agent, a biased expected value of each of the plurality of selection candidates, based on an experience score set for the agent and the expected value of each of the plurality of selection candidates; and
simulating the check action of sequentially checking each of the plurality of selection candidates of the agent, by performing a continuation judgment of determining whether the checking action is to be performed for a next one of the plurality of selection candidates, based on an evaluated value set to a selection candidate that has been already checked and a biased expected value set to a selection candidate that is not checked yet.

11. An apparatus for simulating an agent performing a checking action that sequentially checks a plurality of selection candidates for each of which an expected value is set. the apparatus comprising:
a memory; and
a processor coupled to the memory and configured to:
calculate, for the agent, a biased expected value of each of the plurality of selection candidates, based on an experience score set for the agent and the expected value of each of the plurality of selection candidates; and
simulate the check action of sequentially checking each of the plurality of selection candidates of the agent, by performing a continuation judgment of determining whether the checking action is to be performed for a next one of the plurality of selection candidates, based on an evaluated value set to a selection candidate that has been already checked and a biased expected value set to a selection candidate that is not checked yet.
